(19) United States
(12) Patent Application Publication
(10) Pub. No.: US 2024/0061689 A1
(43) Pub. Date: Feb. 22, 2024

(54) ASYNCHRONOUS CANCELLATION OF REQUESTS FOR PROCESSING ENGINES

(71) Applicant: Microsoft Technology Licensing, LLC, Redmon, WA (US)

(72) Inventors: Yi YUAN, Redmond, WA (US); Hari Daas ANGEPAT, Redmond, WA (US)

(21) Appl. No.: 17/891,770

(22) Filed: Aug. 19, 2022

(51) Int. Cl. G06F 9/445; G06F 9/50

(52) U.S. Cl. CPC G06F 9/44594; G06F 9/5022

(57) ABSTRACT

The present disclosure relates to utilizing a processing engine system to asynchronously cancel outstanding service requests efficiently and flexibly in computing systems. For example, the processing engine system facilitates asynchronous cancellation of requests by utilizing sequence numbers to validate requests at different stages of a request processing flow. In particular, after efficiently performing local cancellation operations, the processing engine system guarantees that resources associated with canceled requests are deallocated and free to process other requests. Indeed, the processing engine system is able to provide this processing resource-free guarantee without contacting or waiting for remote resources to return outstanding processing requests.

### BACKGROUND

Recent years have seen significant hardware and software advancements in computing devices. For instance, many entities increasingly use resources and services offered by cloud computing systems. To perform many of these services, computing devices within computing systems, such as cloud computing systems, receive and process numerous user requests from requesting devices or systems. In one or more instances, a cloud computing system utilizes local resources to process user requests. In some instances, cloud computing systems rely on remote systems to process user requests.

Despite these and other advances, existing computing systems that process user requests face several technical shortcomings that result in inefficient and inflexible computing operations, particularly in the area of canceling outstanding user requests (e.g., user requests that have been made but that are not yet complete). To elaborate, when a cancellation is received to cancel an outstanding user request, existing computer systems often employ a complex cancellation process. For example, some computer systems need to first look up whether a pending user request is being processed locally or remotely. In many instances, the lookup process requires an existing computer system to store additional tracking information for each user request

If a user request is being processed using local resources, many existing computer systems wait for the user request to first finish processing. In some instances, some existing computer systems attempt to locate and track a canceled user request being processed locally, which consumes additional computing resources. In other instances, rather than trying to track down a canceled user request, some existing computer systems block all newly submitted requests from being processed until all outstanding requests have first been completed, which creates a backlog of incoming user requests.

For a user request that has been forwarded to remote computing devices for processing, existing computer systems can either chase after the user request or wait for the remote device to return a request result. In one case, the remote computing device may have forwarded the user request to other devices, in which case, the existing computer systems are unable to identify the current location of the user request to indicate the cancellation or the existing computer systems must navigate through a complex maze of devices to identify the remote computing device that is processing the user request. In other cases, the remote computing devices may have been delayed, timed out, or even gone offline. In these cases, the existing computer systems often inefficiently and inflexibly hold on to local resources that require the returned result to complete processing of the user request, and the existing computer systems are given no indication from the remote devices of when a result will be returned, which causes the local resources to be locked, unavailable, and wasted. In some instances, these returned results may not arrive in a reasonable time frame or not arrive at all.

These problems inefficiently and inflexibly compound as the number of canceled requests increases. For example, in some instances, the requesting device is a virtual machine that shuts down. In doing so, the virtual machine may cancel thousands to millions of user requests, where each request is at a different stage in a request processing flow (and chasing each of these requests is incredibly difficult and inefficient).

Some existing computer systems employ a software solution to make user request cancellation possible. However, this requires the software to synchronize itself at numerous checkpoints and maintain numerous locking mechanisms. As with the above examples, these systems are both inefficient, inflexible, and often require a system to wait for remote results that may not come.

These and other problems result in significant inefficiencies, inaccuracies, and inflexibilities of existing systems regarding canceling user requests currently pending in a request processing flow.

### BRIEF DESCRIPTION OF THE DRAWINGS

The detailed description provides one or more implementations with additional specificity and detail through the use of the accompanying drawings, as briefly described below.

FIGS. 1A-1B illustrate a diagram of a computing system environment where a processing engine system is implemented in accordance with one or more implementations.

FIG. 2 illustrates an example overview for implementing the processing engine system to asynchronously cancel a service request in accordance with one or more implementations.

FIG. 3A-3B illustrate block diagrams of the processing engine system to process service requests utilizing local and remote processing resources in accordance with one or more implementations.

FIG. 4 illustrates a sequence diagram of asynchronously canceling a service request in accordance with one or more implementations.

FIG. 5 illustrates a block diagram of performing request verification checks for processing requests in accordance with one or more implementations.

FIG. 6 illustrates a block diagram of clearing out local processing resources in response to a cancellation request in accordance with one or more implementations.

FIG. 7 illustrates an example series of acts for persisting monitored and processed event data to a persistence store in accordance with one or more implementations.

FIG. 8 illustrates example components included within a computer system.

### DETAILED DESCRIPTION

Implementations of the present disclosure provide benefits and/or solve one or more of the foregoing or other problems in the art with systems, non-transitory computer-readable media, methods, and/or devices that utilize a processing engine system to asynchronously cancel outstanding service requests efficiently and flexibly in computing systems such as cloud computing systems. For example, in various implementations, the processing engine system facilitates asynchronous cancellation of requests by utilizing sequence numbers to validate requests at different stages of a request processing flow. In particular, after efficiently performing local cancellation operations, the processing engine system guarantees that resources associated with canceled requests are deallocated and free to process other requests. Indeed, the processing engine system is able to provide this processing resource-free guarantee without contacting or waiting for remote resources to return outstanding processing requests.

To elaborate, in one or more implementations, the processing engine system processes service requests from requesting devices (or systems), which can include converting a service request into one or more processing requests. As part of generating a processing request, the processing engine system creates a context entry in a request context table that includes, among other information, a sequence number for the processing request.

After receiving the service request, in various implementations, the processing engine system identifies a cancellation indication to cancel the service request. In response, the processing engine system asynchronously cancels the service request by modifying the sequence number in the context entry to indicate that the context entry is now invalid. Additionally, the processing engine system performs request verification checks at various stages of the request processing flow to drop the canceled request and prevent it from accessing the local processing resources.

Furthermore, in some implementations, the processing engine system provides a processing request completion indicator (and/or a clear out monitor) to local processing resources to verify that any processing requests associated with the service request that arrives at the local processing resource before the processing request completion indicator completes processing. After, in various implementations, the processing engine system confirms the cancellation of the service request to the requestor by indicating that the processing request associated with the canceled service request can no longer access any local processing resources.

As described herein, the processing engine system provides several technical benefits in terms of computing efficiency, accuracy, and flexibility compared to existing computing systems. Indeed, the processing engine system provides several practical applications that deliver benefits and/or solve problems associated with real-time edge device metric monitoring and reporting.

To elaborate, in various implementations, the processing engine system improves efficiency by quickly and asynchronously canceling pending or outstanding service requests regardless of where the requests are currently being processed in a request processing flow, even for processing requests residing on one or more remote processing resources. Indeed, the processing engine system efficiently and flexibly cancels requests without having to track down the current location of processing requests. Instead, the processing engine system performs local cancellation operations that prevent the processing engine system from processing canceled requests while allowing non-canceled requests to be processed without delay.

Also, in various implementations, unlike existing computer systems that tie up local resources waiting for remote requests to be returned, which can be an indefinite amount of time, the processing engine system asynchronously cancels a request by updating a request context table to mark a request as invalid as well as clearing out local processing jobs, which the processing engine system quickly performs. In particular, the processing engine system efficiently and flexibly facilitates freeing up local resources immediately upon processing a cancellation request rather than having to lock up local resources for an indefinite period of time. Indeed, the processing engine system guarantees that, after the processing engine system acknowledges a cancellation operation, resources associated with canceled requests are deallocated and can no longer be accessed by the canceled requests. In this manner, the processing engine system ensures that local processing resources are immediately available for other pending requests.

Additionally, the processing engine system does not waste local processing resources processing requests that are later ignored or discarded. To illustrate, in various implementations, the processing engine system utilizes a verification check before processing requests locally to ensure that canceled requests are not processed. In many implementations, the processing engine system utilizes the verification check to drop canceled requests before they advance to the next processing stage of the request processing flow. For example, a verification check includes utilizing sequence numbers in a request context table to efficiently ascertain if a request is valid (e.g., current sequence numbers) or invalid (e.g., obsolete sequence numbers). Additionally, because requests are speedily canceled at the local level, the processing engine system more quickly frees up entries in a request context table, which mitigates the problem of overwriting active entries (as a request context table is often a fixed size that has a limited number of request context entries).

Further, the processing engine system can flexibly scale to any number of cancellation requests. Indeed, unlike existing computer systems that increasingly struggle as the number of cancellation requests builds, the processing engine system efficiently operates with any number of cancellation requests, as cancellations are done locally and asynchronously.

Moreover, the processing engine system can operate as a hardware or a software solution. For example, the processing engine system is implemented on a processing engine that performs one or more implementations described herein. In some implementations, the processing engine system is a software-based set of actions. In various implementations, the processing engine system performs various implementations disclosed herein utilizing both hardware and software components.

As illustrated in the foregoing discussion, the present disclosure utilizes a variety of terms to describe the features and advantages of one or more implementations described herein. For instance, as used herein, operations of the processing engine system utilize one or more processing engines. Accordingly, the term “processing engine” refers to a device, hardware, and/or system that receives and processes incoming requests (e.g., service or user requests). For example, a processing engine is responsible for processing data, usually retrieved from storage devices, based on pre-defined logic, in order to produce a result. In many implementations, the processing engine system includes one or more processing engines. Accordingly, as used herein, the terms processing engine and processing engine system are often interchangeable.

In various implementations, a processing engine is implemented in hardware, such as a hardware pipeline, a hardware accelerator, a finite state machine (FSM), or a processor. In various implementations, a processing engine includes storage having a request context table and local processing resources. In some implementations, a processing engine is implemented in software, or a combination of hardware and software. In many implementations, a computing device, such as a server device, host device, or other types of computing device within a cloud computing system, includes one or more processing engines.

As used herein, the terms “service request” or “user request” refer to a request by a requestor device or system (“requestor”) to a processing engine and/or the processing engine system to process the request. For example, a requestor sends a disk IO request to a processing engine. In one or more implementations, a service request is sent from the same computing device as the processing engine (e.g., a virtual machine on a host device sends a service request to a processing engine on the host device). In some implementations, the requestor is on a separate computing device from the processing engine (e.g., the requestor is on a client device).

As used herein, the term “processing request” refers to requests generated and tracked by a processing engine and/or the processing engine system. For example, upon receiving a service request, the processing engine converts the service request into one or more processing requests needed to fulfill the service request. The processing engine then tracks pending or outstanding processing requests in a request context table. For certain implementations, a processing request is tied, aliased, linked, and/or otherwise associated with a service request. In some implementations, a processing request is processed locally by a processing engine. In various implementations, the processing engine system sends a processing request to and receives responses from other computing devices, such as a remote processing resource or remote service (e.g., a remote back-end storage server).

As used herein, the term “outstanding processing request” refers to a processing request that has started, but not yet completed processing at a processing resource; the term “pending processing request” refers to a generated processing request that is waiting to be processed; and the term “active request” refers to both pending and outstanding requests. To illustrate, a pending request includes a processing request that has been generated from a service request but has not yet begun to be processed or one that is awaiting additional processing (e.g., advancing to the next stage of a request processing flow). For example, a processing request is processed at a remote processing resource. Upon the return of a processed result to the processing request, the processing engine system needs to further process the result at a local processing resource (e.g., for bookkeeping purposes).

As used herein, the term “request context table” refers to a data structure that tracks requests including processing requests currently processing and/or processing requests waiting to be processed. In many implementations, a request context table resides within a processing engine. In a few implementations, a request context table is located elsewhere, such as on the same or different device as a corresponding processing engine. In various implementations, a request context table includes context entries that indicate the request context of a processing request. Additionally, in several implementations, each context entry includes a context identifier, sequence number, and servicing information.

As used herein, the term “context identifier” refers to an identifier of a processing request within a request context table. In various implementations, a context identifier (i.e., request context identifier) serves as a table index (or key) to identify a processing request within the request context table. For instance, the context identifier (“CID”) indicates the physical location on the request context table. Often, a request context table includes a fixed number of context identifiers that are reused over time.

As used herein, the term “sequence number” refers to a unique or mostly-unique identifier assigned to a processing request. In various implementations, a sequence number identifies the processing request for current processing requests. In one or more implementations, the processing engine system generates a sequence number for a processing request. In many implementations, sequence numbers are unique for a reasonable time period, such that processing requests do not repeat with current or processed requests generated in the foreseeable future (e.g., sequence numbers can be repeated after a predetermined amount of time). Additionally, in many implementations, the processing engine system utilizes sequence numbers to validate or invalidate processing requests.

As used herein, the terms “servicing information” or “request servicing information” refer to information and/or instructions in a request context table for serving a processing request. In various implementations, servicing information is based on the request type. For example, for a disk read service request, the servicing information for a corresponding processing request includes which disk to read, the logical block address to access, and/or the number of blocks to read. In various implementations, the servicing information of a processing request is updated as part of the normal processing flow of the request. For example, the servicing information of a processing request includes information on the sub-parts of the processing request have completed and the sub-parts that are still outstanding (e.g., and/or used to determine when the associated service request is completed).

As noted above, the processing engine system can process processing requests locally or send them to be processed remotely. In various implementations, the processing engine system attaches a token to a processing request being processed by a processing resource. As used herein, the terms “token” or “request token” refer to identifying information attached to a processing request being processed. In various implementations, a token includes the context identifier and sequence number of a processing request. For instance, for processing requests that the processing engine system sends to a remote computing device, the token attaches to and/or travels with the processing requests as it is processed and also returns with the processing results. In this manner, the processing engine system can match the incoming processing results with outgoing processing requests. In one or more implementations, the processing engine system also utilizes tokens with processing requests being processed on local processing resources.

As used herein, the terms “request cancellation indication,” “cancellation request,” “service request cancellation,” and “processing request cancellation” refer to an indication for canceling or terminating a previous or pending service request. In various implementations, the processing engine system processes a cancellation request by halting or stopping the processing and handling of a service request (or associated processing requests). In some implementations, the processing engine system responds to a cancellation request by deallocating resources that are being used to service a request and/or indicating that the request no longer has access to resources previously used to process the request. In some implementations, the processing engine system provides a list (e.g., to a requestor) of outstanding service requests that got canceled. Additional information regarding cancellation requests is provided below. In example implementations, the addition of the term “asynchronously” indicates that the processing engine system cancels a request locally at a processing engine without needing to wait for a confirmation or response from another device.

As used herein, a “cloud-computing system” refers to a network of connected computing devices that provide various services to computing devices (e.g., client devices, server devices, provider devices, customer devices, etc.). For instance, as mentioned above, a distributed computing system can include a collection of physical server devices (e.g., server nodes) organized in a hierarchical structure including clusters, computing zones, virtual local area networks (VLANs), racks, fault domains, etc. In various implementations, the network is a virtual network or a network having a combination of virtual and real components. Often, cloud computing systems utilize computing devices that include parity-based SSD schemes to facilitate cloud storage, virtual machines, and/or other services

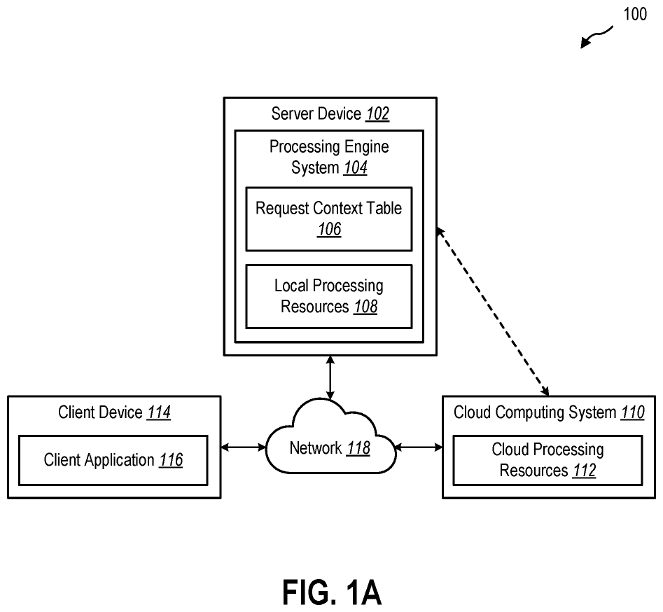

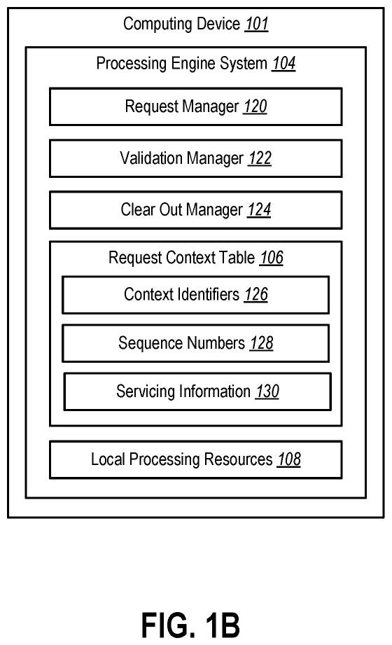

Additional details will now be provided regarding the components and elements of the processing engine system (i.e., the processing engine system). For example, FIGS. 1A-1B illustrate a schematic diagram of an environment 100 for implementing a processing engine system 104. In particular, FIG. 1A includes the environment 100 and FIG. 1B provides additional detail regarding components and elements of the processing engine system 104.

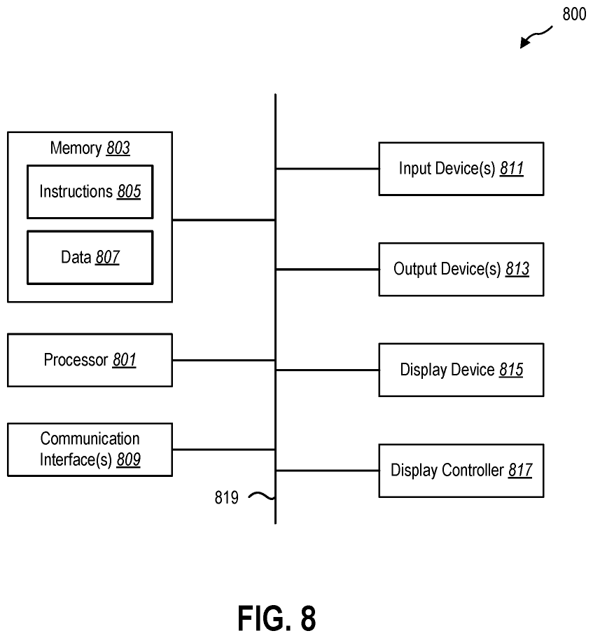

As shown in FIG. 1A, the environment 100 includes a server device 102 that includes a processing engine system 104, a cloud computing system 110 having cloud processing resources 112, and a client device 114 having a client application 116 each connected via a network 118. As shown, the processing engine system 104 includes a request context table 106 and local processing resources 108. Additional details regarding these and other computing devices are provided below in connection with FIG. 8. In addition, FIG. 8 also provides additional details regarding networks, such as the network 118 shown.

As mentioned above, the environment 100 includes the server device 102. The server device 102 may include one computing device or may be distributed across multiple computing devices. In some implementations, the server device 102 is part of the cloud computing system 110, as indicated by the dashed line.

As shown, the server device 102 includes the processing engine system 104, which, in some instances, represents a processing engine. In one or more implementations, the processing engine system 104 facilitates receiving, processing, and returning service requests to the requestor. In some implementations, the requestor is located on the server device 102 and/or is within the cloud computing system 110. In example implementations, the server device 102 includes multiple processing engines.

As mentioned above, the processing engine system 104 includes the request context table 106 and the local processing resources 108. In various implementations, the processing engine system 104 utilizes the request context table 106 to track and monitor outstanding requests. In some implementations, the processing engine system 104 utilizes the local processing resources 108 to process service requests (i.e., processing requests associated with service requests). As used herein, the term “local processing resources” includes hardware or software components for processing one or more processing requests locally. The local processing resources 108 include a hardware processing pipeline in various implementations. Additional details regarding the processing engine system 104 are provided below in the subsequent figures. For example, details and components of the processing engine system 104 are further provided below in connection with FIG. 1B.

As shown, the environment 100 includes the cloud computing system 110 having the cloud processing resources 112. In one or more implementations, the processing engine system 104 sends a processing request to the cloud processing resources 112 on the cloud computing system 110 to remotely process one or more processing requests associated with a service request. In many implementations, the cloud processing resources 112 represent a remote processing resource. As used herein, a “remote processing resource” refers to a processing resource that is located separately from a processing engine on the processing engine system 104. For example, the processing engine system 104 sends a processing request to a remote machine to be processed by a remote processing resource.

In various implementations, the cloud computing system 110 includes additional computing devices not shown. In some implementations, the cloud processing resources 112 utilize one or more computing devices, including storage devices, to process requests sent by the processing engine system 104. For example, the cloud processing employs a chain of computing devices, systems, and/or functions to generate a request result for a received processing request.

As shown, the environment 100 includes the client device 114 having the client application 116. Among various implementations, the client device 114 is a user client device or an administrator client device that provides service requests to the processing engine system 104. In some implementations, the processing engine system 104 provides an interactive graphical user interface for making requests and/or implementing policies that make service requests of the processing engine system 104 (e.g., the client device 114 is a requestor). In various implementations, the client application 116 is provided by and/or communicates with the processing engine system 104 to facilitate device and user interactions with the processing engine system 104.

As mentioned above, FIG. 1B provides additional details regarding the capabilities and components of the processing engine system 104. As shown, a computing device 101 includes the processing engine system 104. As also shown, the processing engine system 104 includes various components and elements, which are implemented in hardware and/or software. To illustrate, FIG. 1B shows the processing engine system 104 having a request manager 120, a validation manager 122, a clear out manager 124, the request context table 106, and the local processing resources 108. As also illustrated, the request context table 106 includes content identifiers 126, sequence numbers 128, and servicing information 130.

As shown, the processing engine system 104 includes the request manager 120. In one or more implementations, the request manager 120 receives, accesses, collects, identifies, converts, modifies, provides, groups, labels, or otherwise manages service requests from requestors (e.g., requesting devices or systems). For example, the request manager 120 receives incoming service requests, utilizes logic-based heuristics to generate one or more associated processing requests, and adds the one or more processing requests to the request context table 106. In some implementations, the request manager 120 ensures that processing requests added to the request context table 106 are given content identifiers 126, sequence numbers 128, and servicing information 130. The request manager 120 can then track a processing request based on its context in the request context table 106.

In various implementations, the request manager 120 also facilitates receiving cancellation indications from a provider or otherwise identifying a cancellation indication. For example, the request manager 120 receives a cancellation request for a pending or outstanding service request. In another example, the request manager 120 determines that a requestor device, such as a virtual machine, has gone offline and that all outstanding service requests from the requestor device should be canceled. In response to detecting one or more cancellation indications, in one or more implementations, the request manager 120 modifies the sequence numbers 128 of one or more processing requests associated with one or more service requests in the request context table 106.

Additionally, in one or more implementations, the processing engine system 104 includes the validation manager 122. In various implementations, the validation manager 122 facilitates validating processing requests. For example, the validation manager 122 utilizes a verification check to determine whether pending processing requests can be processed, whether outstanding processing requests can continue to process, or whether they should be dropped and discarded. In some instances, the validation manager 122 performs verification checks prior to processing requests being processed by local processing resources 108. For instance, in one or more implementations, the validation manager 122 verifies that a pending or outstanding processing request has a valid sequence number that matches a corresponding sequence number in the request context table 106 for the same request context. As a result, any local or remote processing results that require further processing will need to pass a verification check before proceeding. Otherwise, if canceled, the validation manager 122 drops the invalid, canceled request without further wasteful processing.

As shown, the processing engine system 104 includes the clear out manager 124. In various implementations, the clear out manager 124 ensures that the local processing resources 108 are free from outstanding processing requests. For example, in one or more implementations, the clear out manager 124 sends a clear out monitor (i.e., a processing request completion indicator) to the local processing resources 108 to flush, drain, or otherwise clear out the local processing resources 108 (and/or additional local processing resources) to ensure that all outstanding processing requests have cleared the local processing resources. In this manner, the processing engine system 104 guarantees that any canceled outstanding service requests are no longer accessing local resources.

As additionally shown, the processing engine system 104 includes the request context table 106. As defined above, in many implementations, a request context table is a table or other data structure of a fixed size that stores request context for processing requests. Because the request context table 106 is often fixed in size, the content identifiers 126 are recycled often. Accordingly, canceling a processing request by removing it from the request context table 106 may be insufficient because the same content identifier may quickly be added back to the table and used by another processing request. Thus, when determining the request validity based on the presence of a particular content identifier in the request context table 106 will occasionally trigger false positive results. However, if the requested context table 106 is too large to preclude reusing a content identifier too frequently, the processing engine system 104 is wasting valuable storage space by unnecessarily hosting a massive, sparse table.

As shown, the processing engine system 104 includes the local processing resources 108. In various implementations, the local processing resources 108 is an on-chip processing pipeline and/or finite state machine. In example implementations, the local processing resources 108 is a virtualized processing pipeline resource. In one or more implementations, the local processing resources 108 provides a request processing flow for processing one or more processing requests. Some implementations include processing requests that are sent to remote processing resource return and their results are run through the local processing resources 108 (e.g., a processing pipeline resource) before signaling to the requestor device that the service request has been completed.

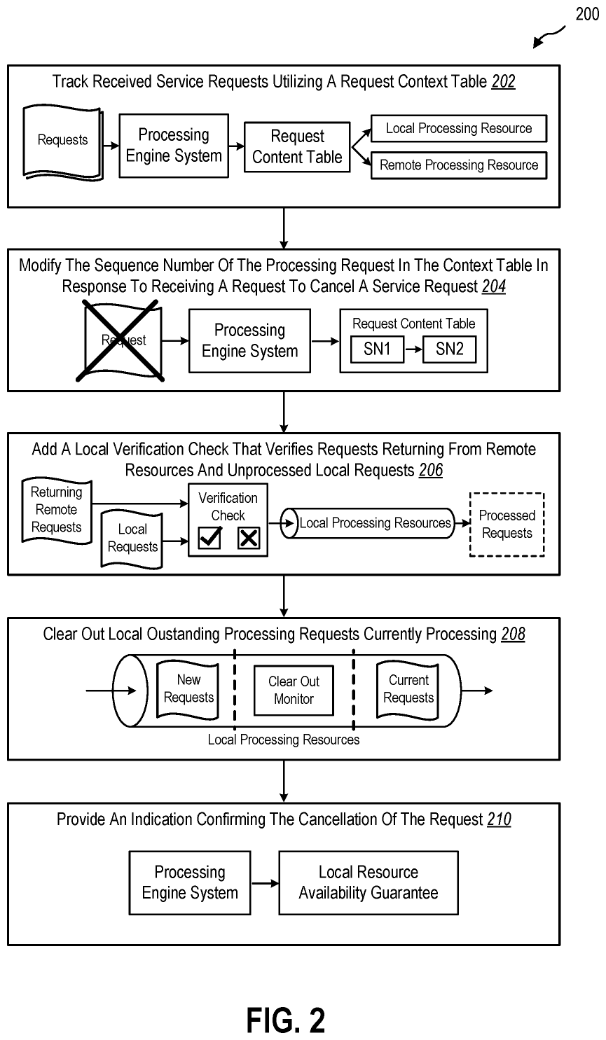

Additional details in connection with an example implementation of the processing engine system 104 are discussed in connection with FIG. 2. For example, FIG. 2 illustrates an example overview for implementing the processing engine system to asynchronously cancel a service request in accordance with one or more implementations. As shown, FIG. 2 illustrates a series of acts 200 performed by the processing engine system 104.

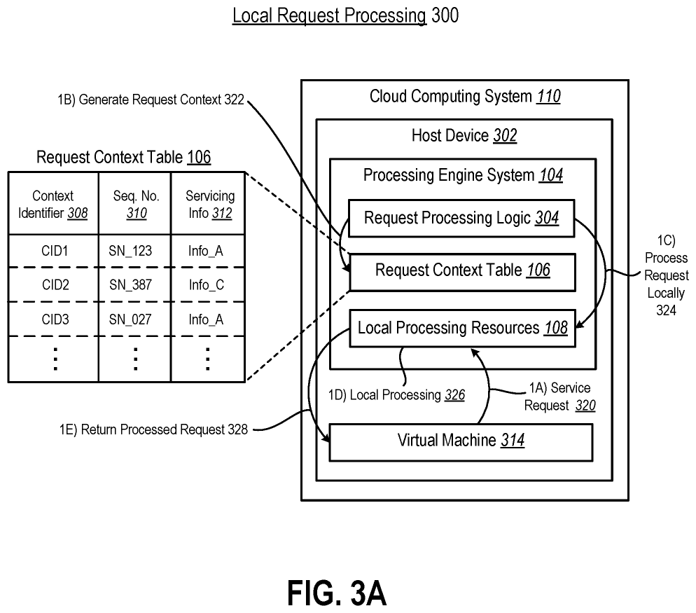

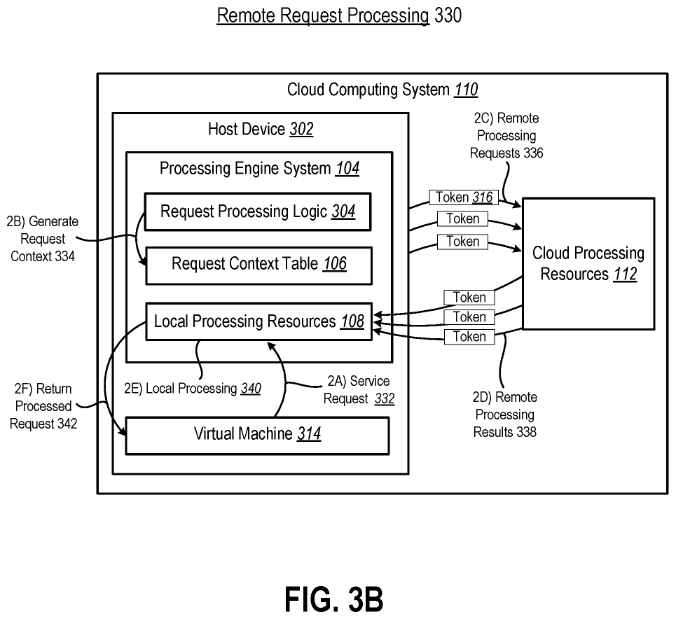

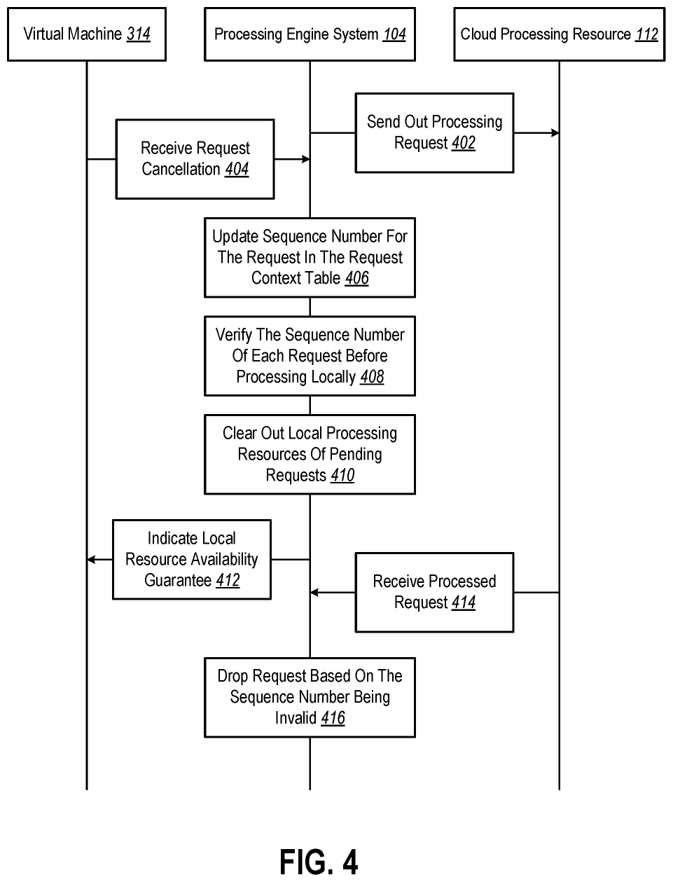

In particular, the series of acts 200 in FIG. 2 includes an act 202 of tracking received service requests utilizing a request context table. For example, in various implementations, the processing engine system 104 receives a service request from a requestor. In response, the processing engine system 104 generates one or more processing requests and provides the processing requests to a local processing resource and/or a remote processing resource. Additionally, in various implementations, the processing engine system 104 adds the processing requests to a request context table to track the general status and/or location of pending and outstanding processing requests. For example, the processing engine system 104 adds a request context for a processing request to the request context table with a context identifier, sequence number, servicing information, and/or other information. Additional details regarding monitoring processing requests associated with service requests are provided below in connection with FIGS. 3A, 3B, and 4.

In addition, FIG. 2 shows that the series of acts 200 includes an act 204 of modifying the sequence number of the processing request in the request context table in response to receiving a request to cancel a service request. For instance, the processing engine system 104 identifies a cancellation indication with regard to an active service request. In response, the processing engine system 104 identifies one or more processing requests in the request context table that are associated with the service request. Further, the processing engine system 104 asynchronously cancels the request by locally modifying the sequence number of each identified processing request in the request context table. Additional details regarding receiving and responding to cancellation indications are provided below in connection with FIG. 4.

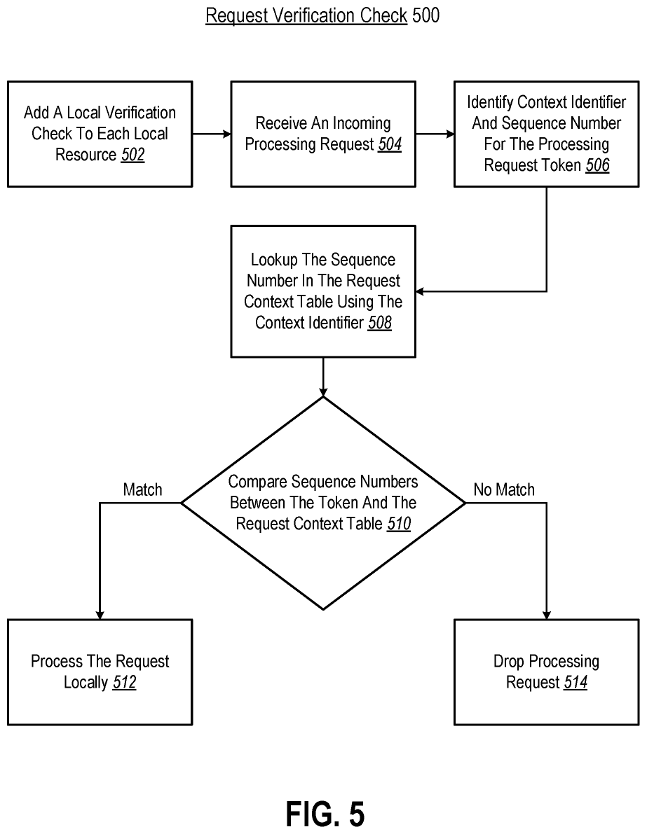

As also shown, the series of acts 200 includes an act 206 of adding a local verification check that verifies requests returning from remote resources and unprocessed local requests. For example, in one or more implementations, the processing engine system 104 produces a verification check that attaches to local processing resources, such as one main verification check or a verification check in front of each local processing resource, to validate all pending processing requests. Once in place, pending processing requests need to satisfy the verification check before proceeding to a local processing resource for processing and completion. As noted above, in many implementations, the processing engine system 104 utilizes sequence number comparisons and matches to verify that a pending processing request is valid. Additional details regarding a verification check are provided below in connection with FIGS. 4 and 5.

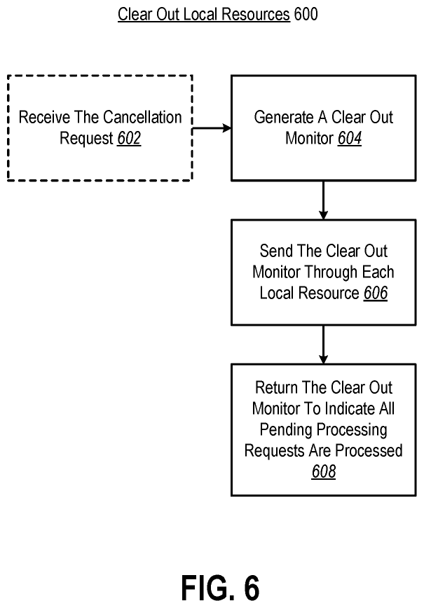

In addition, FIG. 2 shows that the series of acts 200 includes an act 208 of clearing out local outstanding processing requests currently processing. For example, in various implementations, the processing engine system 104 generates and provides a clear out monitor (i.e., a processing request completion indicator) to one or more local processing resources to ensure that any processing requests outstanding at the time the cancellation indication was received complete processing. In this manner, the processing engine system 104 ensures that all outstanding processing requests are completed without needing to determine if one or more of the outstanding requests corresponds to the cancellation indication and thus frees up any resources being used by a canceled processing request. Additionally, the processing engine system 104 ensures that pending processing requests can utilize local processing resources as long as they follow behind the clear out monitor. Additional details regarding utilizing a clear out monitor are provided below in connection with FIGS. 4 and 6.

As also illustrated, the series of acts 200 includes an act 210 of providing an indication confirming the cancellation of the service request. For example, in various implementations, the processing engine system 104 receives confirmation that the verification check is in place as well as that the clear out monitor has completed flushing or draining out local processing resources. In response, in various implementations, the processing engine system 104 provides an indication to the requestor device guaranteeing that resources associated with canceled requests are deallocated and available to process other requests. Additionally, the processing engine system 104 provides this resource-free guarantee or warranty without waiting for remote resources to return as any canceled processing request that returns from remote devices will be dropped after quickly identifying that it has been canceled.

As noted above, FIGS. 3A-3B provides more details for monitoring processing requests associated with service requests. For example, FIG. 3A-3B illustrate block diagrams combined with a set of actions by the processing engine system for processing service requests utilizing local and remote processing resources in accordance with one or more implementations. In particular, FIG. 3A illustrates utilizing local processing resources to complete processing requests and FIG. 3B illustrates utilizing both remote processing resources and local processing resources to complete processing requests. With the background provided in FIGS. 3A-3B, FIGS. 4-6 provide additional detail regarding canceling active requests.

As illustrated, both FIGS. 3A and 3B include the cloud computing system 110 introduced above. In particular, the cloud computing system 110 includes a host device 302, which can represent the server device 102 described above. Additionally, as shown, the host device 302 includes the processing engine system 104 and a virtual machine 314. While not shown for simplicity, the host device 302 can include multiple virtual machines. Further, each virtual machine can include components, such as processors, instructions, memory, etc. Also, the host device 302 can include other components, such as a hypervisor, a processor, memory, storage, peripheral devices, etc.

Additionally, the processing engine system 104 in both FIGS. 3A and 3B include a request processing logic engine 304, the request context table 106, and the local processing resources 108. In some implementations, the request processing logic engine 304 represents a version of the request manager 120, the validation manager 122, and/or the clear out manager 124 described above in connection with FIG. 1B. Also, the request context table 106, and the local processing resources 108 can correspond to similar components described previously. For example, the request context table 106 includes request contexts for each processing request, which includes, among other possible items, a context identifier 308, a sequence number 310, and servicing information 312.

Turning to FIG. 3A, as shown, this figure illustrates the local request processing 300 of a service request. To illustrate, the virtual machine 314 running on the cloud computing system 110 performs a variety of services for a user (e.g., the virtual machine 314 provides web or data analytics for an entity). As part of its functionality, the virtual machine 314 (i.e., a requestor) makes a service request to the processing engine system 104, which is shown as Act 1A 320. For example, the virtual machine 314 sends a disk I/O (input/output) request to the processing engine. For instance, the virtual machine 314 has local storage where the disk I/O of the virtual machine is serviced using block storage abstraction by the host device 302.

As shown, the processing engine system 104 receives the service request and utilizes the request processing logic engine 304 to begin processing the service request. For example, the request processing logic engine 304 generates one or more processing requests from the service requests. In connection with generating a processing request associated with the service request, the request processing logic engine 304 can generate a request context within the request context table 106, shown as Act 1B 322. As shown, the generated request context for a processing request includes a context identifier 308, a sequence number 310, and servicing information 312.

In various implementations, the request processing logic engine 304 selects a context identifier 308 that is available. In one or more implementations, the request context table 106 includes context identifiers that are fixed and correspond to an entry number, key, or index in the request context table 106.

Additionally, the request processing logic engine 304 can generate a unique sequence number for the processing request. As noted, sequence numbers uniquely identify a processing request. In some implementations, the processing engine system 104 generates a sequence number that remains unique for a time frame that corresponds to processing or referencing a processing request (e.g., for a reasonable processing time window). Indeed, a processing request should not be assigned to a sequence number that was used or made available within a threshold period of time (e.g., a day, days, or a week after of becoming available).

In various implementations, the time frame includes abnormal cases, such as when a processing request takes an extended time to complete processing. For example, the processing engine system 104 utilizes 48-bit or 64-bit values to store sequence numbers, which provides a time frame of a few months before a sequence number would be repeated. However, given the above factors, in example implementations, the processing engine system 104 keeps the sequence number size as small as possible to maximize storage efficiency. In particular, the size of a sequence number is increased or decreased based on the type of application or request processing flow being used.

As shown, upon generating a request context, the processing engine system 104 performs Act 1C 324 of processing the request locally. Additionally, the local processing resources 108 complete the processing request, as shown in Act 1D 326. For example, the processing engine system 104 sends the processing request to the local processing resources 108 to perform the disk I/O read and/or write at a local storage disk. In various implementations, the local processing resources 108 handling a processing request is referred to as a short-latency operation, as the time to complete the request is brief.

In some but not all implementations, the processing engine system 104 pairs a request token with the processing request sent to the local processing resources 108. For example, a request token includes the context identifier and sequence number assigned to a processing request. In this manner, the processing engine system 104 monitors active processing requests (e.g., outstanding and pending requests) and correctly identifies them upon their return. In alternative implementations, the processing engine system 104 does not send a token when utilizing the local processing resources 108 to process requests.

As shown, the processing engine system 104 performs Act 1E 328 of returning the processed request (e.g., a processed result). For instance, upon receiving a processed request from the local processing resources 108, the processing engine system 104 utilizes the context identifier and the sequence number in the request token to match the processed result to the processing request and/or the service request (e.g., via the request context table 106). When multiple processing requests are generated for a service request, the processing engine system 104 waits for some or all of the processing requests to be returned. Further, the processing engine system 104 returns the results of the service request (e.g., the processed request(s)) to the virtual machine 314 (i.e., the requestor). In alternative implementations, the processing engine system 104 indicates to the virtual machine 314 that the service request has been completed (e.g., data has been successfully written to a storage disk).

While FIG. 3A corresponds to processing requests locally, FIG. 3B expands the concept to utilizing remote processing resources. To illustrate, FIG. 3B shows remote request processing 330 of a service request. In addition to the components in FIG. 3A, the cloud computing system 110 in FIG. 3B adds the cloud processing resources 112, which is also introduced above.

As shown, the processing engine system 104 performs Act 2A 332 of receiving a service request from the virtual machine 314. As before, the service request may be a disk I/O request. However, in this case, the virtual machine 314 has attached virtual disks (i.e., storage devices) where the I/O operations to the virtual disks are serviced by the host device 302. In this case, to process the service request, the processing engine system 104 sends one or more processing requests to remote storage on a back-end server (e.g., on the cloud processing resources 112).

To illustrate, the processing engine system 104 performs Act 2B 334 of the processing engine system 104 generating a request context for one or more processing requests. As before, the request processing logic engine 304 of the processing engine system 104 utilizes logic-based heuristics to generate one or more processing requests that directly correspond to the service request. Then, as part of generating processing requests, the request processing logic engine 304 generates a request context in the request context table 106 for generated processing requests.

As shown in Act 2C 336, the processing engine system 104 sends one or more remote processing requests to the cloud processing resources 112 (e.g., a remote processing resource). For example, the processing engine system 104 sends a processing request with an accompanying token 316 to the cloud processing resources 112 to be processed remotely. In some implementations, the processing engine system 104 sends processing requests to different or multiple remote processing resources. In example implementations, a remote processing resource handling a processing request is referred to as a long-latency operation, as the time to complete the request is longer than short-latency operations, often unknown, and sometimes indefinite.

In various implementations, the cloud processing resources 112 complete the processing request and provide the remote processing results back to the processing engine system 104, as shown in Act 2D 338. As shown, the processing engine system 104 receives the processed request along with the corresponding token that includes the content identifier and the sequence number associated with the process request. Indeed, the token 316 travels with the process request from its creation to its completion. In this manner, the processing engine system 104 can accurately track processing requests as they are sent and received back from remote processing resources.

With respect to the remote processing resources, in some implementations, the cloud processing resources 112 utilizes multiple components, devices, or functions to complete a processing request. As noted, in many instances, upon sending a processing request to the cloud processing resources 112 for processing, the processing engine system 104 does not know and/or is not able to track the remote progress of the processing request. Further, the processing request may be split into multiple instances unbeknownst to the processing engine system 104. Thus, trying to track down a processing request sent to a remote processing resource is infeasible in most cases. Rather, the processing engine system 104 must wait for the remote processing resource to return a completed request.

Upon receiving processed results, the processing engine system 104 performs local processing of the processing request after receiving processed results, which is shown in Act 2E 340. For example, the processing engine system 104 sends the processed results through a processing pipeline to locally record and/or complete processing of the processing request. For instance, in some instances, the processing pipeline removes the request context from the request context table 106 for the processing request to signal completion of the processing request.

Additionally, the processing engine system 104 performs Act 2F 342 of returning the processed request to the virtual machine 314 (i.e., the requestor). For instance, the processing engine system 104 provides information in response to the service request and/or an indication that the service request has been completed.

While FIGS. 3A and 3B describe and illustrate the processing engine system 104 processing service requests, in many implementations, FIGS. 4-6 provide additional detail regarding asynchronously canceling active requests. To elaborate, active service requests may be canceled for several reasons. For example, reasons for request cancellation include a service request or processing request timing out, a network connection disconnects on which the request was sent (and on which response results are expected to be received), hardware or software updates (e.g., the operating system, software driver, or firmware running on the processing engine needs to be serviced/upgraded), the requestor device that provides the request is terminated (e.g., the session terminates), unmounts a necessary disk, or shuts down (e.g., a virtual machine sending service requests shuts down).

Regardless of the reason for cancellation, when the processing engine system 104 identifies a cancellation indication for a service request, the processing engine system 104 can quickly and efficiently stop the request from prolonged processing and free-up local processing resources being used by canceled requests, even for outstanding processing requests sent out to remote processing resources whose completion status and timing are unknown. Indeed, the processing engine system 104 facilitates the asynchronous (e.g., local) canceling any number of outstanding requests regardless of where they are currently being processed or what processing stage they are at in a request processing flow.

To further illustrate, FIG. 4 shows a sequence diagram of asynchronously canceling a service request in accordance with one or more implementations. As shown, FIG. 4 includes the virtual machine 314, the processing engine system 104, and the cloud processing resources 112, each of which are introduced above. In particular, FIG. 4 includes a series of acts 400 with respect to the processing engine system 104 processing requests as well as interacting with the virtual machine 314 (e.g., a requestor) and the cloud processing resources 112 (e.g., remote processing resources).

As shown, the series of acts 400 includes an act 402 of the processing engine system 104 sending out a processing request. For example, the processing engine system 104 receives a service request from the virtual machine 314, generates a processing request associated with the service request, and sends off the processing request to the cloud processing resources 112 for remote processing, as described above.

As also shown, the series of acts 400 includes an act 404 of receiving a request cancellation from the virtual machine 314. For example, a requestor device sends a cancellation request for a current, active service request to the processing engine system 104. In various implementations, the processing engine system 104 automatically detects a cancellation indication, such as from a network disconnection or when the requestor device stops responding.

In various implementations, the processing engine system 104 receives criteria for canceling requests. For example, a requestor provides an indication to cancel all requests made on behalf of a specific virtual machine. In another example, the requestor indicates canceling all requests sent before a particular timestamp. In some instances, a cancellation request indicates canceling all service requests of a given type (e.g., disk I/O reads). Based on the criteria indicated in a cancellation request, the processing engine system 104 finds each service request and the corresponding processing requests to cancel.

Upon receiving the cancellation requests, the processing engine system 104 begins the process of asynchronously canceling the service request. In one or more implementations, the processing engine system 104 identifies each of the processing requests that are associated with the service request. In particular, in various implementations, the processing engine system 104 locates request contexts for the corresponding processing requests in a request context table. Additionally, in various implementations, for each processing request, the processing engine system 104 updates the sequence number for the request (i.e., request context) in the request context table, as shown in the act 406 in the series of acts 400.

The processing engine system 104 can update the sequence number of a processing request in a variety of ways. In one or more implementations, the processing engine system 104 increments the sequence number to a new unique number. In some implementations, the processing engine system 104 changes the most-significant bit of the sequence number. In example implementations, the processing engine system 104 changes the sequence number to a number or a range of numbers that correspond to canceled requests (e.g., the sequence number of 0 or the range 1-10 is used for canceled requests).

In various implementations, changing the sequence number of a processing request in the request context table initiates the process of canceling a processing request. For example, in one or more implementations, by changing the sequence number, the processing engine system 104 renders the context invalid; that is, the processing engine system 104 invalidates and/or deallocates the request context of a processing request. In some implementations, modifying the sequence number of a processing request allows the context entry in the request context table to be overwritten by an incoming processing request. In various implementations, the processing engine system 104 utilizes additional or alternative methods to provide a request context (e.g., context entry) in the request context table invalid for a canceled request.

As part of canceling a request, the processing engine system 104 can ensure that only processing requests with valid sequence numbers can continue processing at each stage of the request processing flow. In particular, because the processing engine system 104 has control over processing that occurs at the cloud processing resources 112, in various implementations, the processing engine system 104 verifies the sequence number of each request before performing local processing, as shown in the act 408 in the series of acts 400. In this manner, pending processing requests that are needing to be processed locally must first be validated or they will be dropped. Additional details regarding verifying the sequence number of processing requests are provided below in connection with FIG. 5.

As shown, the series of acts 400 includes an act 410 of the processing engine system 104 clearing out local processing resources of processing requests. For example, once the cancellation request is received, outstanding requests being processed locally must complete processing to ensure that request processing flows are free of canceled requests. In various implementations, the processing engine system 104 utilizes a clear out monitor to drain or flush outstanding processing requests. Additional details regarding clearing out outstanding processing requests are provided below in connection with FIG. 6.

Additionally, the series of acts 400 includes an act 412 of the processing engine system 104 indicating a local resource availability guarantee to the virtual machine 314 (e.g., the requestor). In particular, once a sequence number verification check has been established for preventing canceled requests from using local processing resources coupled with the local process in resource being cleared of canceled requests, the processing engine system 104 can guarantee to requestors that any resources associated with the canceled requests are now available for use by other processing requests. Indeed, the processing engine system 104 can guarantee that it will no longer have access to any resources associated with the canceled requests and that all resources for the cancelation requests have been deallocated. In many instances, as soon as a local resource becomes available, the processing engine system 104 will efficiently use it, which may occur before the guaranteed indication is provided to the requestor.

As opposed to existing computer systems, which often require a processing engine to wait for all pending and outstanding processing requests to return from remote sources to complete cancellation of a service request, the processing engine system 104 described herein can asynchronously execute the processing request in a matter of moments. More specifically, in many implementations, the processing engine system 104 needs only to perform local actions to cancel a request and the time to complete the cancellation operation is approximately the sum of the time needed to update corresponding sequence numbers in the request context table plus the time to clear out the local processing resources utilized by the processing engine system 104 (or less if being performed in parallel). As noted above, while the time taken to clear out the local processing resources depends on the number of outstanding processing requests, these requests clear out in a brief time frame.

Moreover, the processing engine system 104 described herein does not need to wait for remote sources to return request results to guarantee the availability of local processing resources. To illustrate, FIG. 4 includes a dashed line 414 that represents the passage of time where remote processing requests are being processed at the cloud processing resources 112. This passage of time may be short, long, or, in some cases, indefinite.

As shown, the series of acts 400 includes an act 416 of the processing engine system 104 receiving a processed request from the cloud processing resources 112. For example, the processing engine system 104 receives, at the passage of time, a processed request from the cloud processing resources 112 in response to sending out a remote processing request (e.g., the act 402). As described above, the processed request includes a request token having the content identifier and the sequence number assigned to the processing request. It is important to note that the sequence number in the token being returned will be the non-modified sequence number originally generated for the process request. Indeed, because the processing request was sent to the cloud processing resources 112 before the processing engine system 104 received the cancellation request, the return token does not have the modified sequence numbers in the request context table.

As also shown, the series of acts 400 includes an act 418 of the processing engine system 104 dropping the request based on the sequence number being invalid. As provided further below, the processing engine system 104 will use the context identifier in the token to look up the request context of the processing request in the request context table, then identify the corresponding sequence number. Because context identifiers are fixed in the request context table, the processing engine system 104 will identify a request context for a processing request based on the context identifier. However, the request context may correspond to the canceled request context or to a new processing request that has been written to the request context table reusing the same context identifier. Accordingly, the processing engine system 104 utilizes the sequence number to verify if the processing request is valid. Because, in this case, the processing request has been canceled, the sequence numbers will not match and the processing engine system 104 will drop the processing request, as further described below.

As mentioned above, FIG. 5 provides additional details regarding verifying the sequence number of processing requests to identify valid and invalid processing requests. In particular, FIG. 5 illustrates a block diagram of performing a request verification check of processing requests in accordance with one or more implementations. As shown, FIG. 5 includes a series of acts 500 performed by the processing engine system 104.

As illustrated, the series of acts 500 includes an act 502 of adding a request verification check to each local processing resource. As noted above, a request verification check determines if a processing request is valid and authorized to continue processing at a local processing resource. In various implementations, if the local processing resources include multiple processing pipelines, the processing engine system 104 provides a request verification check in front of each pipeline. In alternative implementations, the processing engine system 104 utilizes one request verification check for multiple processing pipelines. In some implementations, the processing engine system 104 provides a request verification check to each local processing resource in connection with implementing or programming the local processing resource. In other implementations, the processing engine system 104 provides the resource verification check after creating, programming, or coding a local processing resource.

As also illustrated, the series of acts 500 includes an act 504 of receiving an incoming processing request. For example, the processing engine system 104 identifies a pending processing request needing to be processed at a local processing resource. In some cases, the pending processing request arrives from a remote processing resource and needs local processing to be completed. In various cases, the pending processing request is otherwise awaiting local processing. For instance, the pending processing request just finished a first stage of processing by one local processing resource and is awaiting additional local processing to be completed. As noted above, in many implementations, the incoming processing request includes a request token having the context identifier and sequence number of the processing request.

Additionally, as shown, the series of acts 500 includes an act 506 of identifying the context identifier and sequence number for the processing request token. For example, the processing engine system 104 parses the processing request to identify the request token. Further in various implementations, the processing engine system 104 identifies the context identifier and the sequence number of the process and the request from the request token. As noted above, the request token includes to the original, non-modified sequence number of the processing request.

FIG. 5 also shows the series of acts 500 including an act 508 of looking up the sequence number in the request context table using the context identifier. In various implementations, the processing engine system 104 utilizes the context identifier for the processing request identified from the request token to look up the request context for the processing request on the request context table. Once the request context for the processing request is identified, the processing engine system 104 identifies the current sequence number stored in the request context table.

As shown, the series of acts 500 includes an act 510 of comparing sequence numbers between the token and the request context table. For example, the processing engine system 104 compares the original sequence number from the token to the current sequence number in the request context table to determine whether they match. If the processing request has not been canceled, then these sequence numbers will match, as the processing engine system 104 will keep the sequence number unchanged for as long as the processing request is active (e.g., not canceled or completed). Otherwise, if the processing request is canceled, the processing engine system 104 will have replaced the sequence number with a modified sequence number. In some instances, the processing engine system 104 will have further replaced the sequence number by overriding the request context with a new processing request that shares the same context identifier but has a new unique sequence number.

To further illustrate, when the sequence numbers match, the series of acts 500 includes an act 512 of processing the request locally. For example, the processing engine system 104 determines that the processing request is valid based on its status in the request context table and allows it to continue on to the local processing resource to be processed and completed.

Otherwise, if the sequence numbers do not match, the series of acts 500 includes in act 514 of dropping the processing request. In these implementations, the processing engine system 104 is unable to validate the incoming process request. Indeed, the processing engine system 104 determines that the processing request has been canceled and is no longer valid. As a result, the processing engine system 104 drops the incoming process and request/result. Further, the processing engine system 104 does not allow the processing request to access the local processing resources, including any resources previously associated with the canceled request, as they have been deallocated at the time the request was asynchronously canceled. Further, in many implementations, the processing engine system 104 prevents any additional fields of the processing request from being accessed before the validity of the processing request is first confirmed, thus ensuring that computing resources are not wasted on handling portions of a canceled processing request.

As noted above, FIG. 6 provides additional details regarding clearing out outstanding processing requests. In particular, FIG. 6 illustrates a block diagram of clearing out local processing resources in response to a cancellation request in accordance with one or more implementations. As shown, FIG. 6 includes a series of acts 600 performed by the processing engine system 104.

As shown, the series of acts 600 includes an act 602 of receiving the cancellation request. As provided above, the processing engine system 104 can detect a cancellation indication of one or more service requests directly or indirectly.

In addition, the series of acts 600 includes an act 604 of generating a clear out monitor. For example, in various implementations, the processing engine system 104 generates, selects, accesses, or instructs, one or more clear out monitors for use. For instance, the processing engine system 104 obtains a clear out monitor for each local processing resource performing functions on the processor engine. Further, the act 604 can include sending a clear out monitor to each of the local processing resources. In some implementations, the clear out monitor is a type of processing request that local processing resources process similar to other processing requests.

In some instances, the clear out monitor includes a processing request completion indicator. In various implementations, the processing engine system 104 provides a processing request completion indicator to each local processing resource upon receiving the cancellation request. In one or more implementations, as part of generating the clear out monitor, the processing engine system 104 sets a processing request completion indicator to false or null.

As shown, the series of acts 600 includes an act 606 of sending the clear out monitor through each local processing resource. For example, the processing engine system 104 sends the clear out monitor and/or a process request completion indicator through each local processing resource. In various implementations, the clear out monitor follows all outstanding processing requests in a local processing resource and exits when all preceding processing requests have completed processing. In some implementations, the processing engine system 104 sets the processing request completion indicator to be positive or true upon clearing out a local processing resource.

In some instances, the clear out monitor flushes, drains, and/or pushes outstanding processing requests through a local processing resource and/or out of the local processing resource. For example, if while traversing through a local processing resource, the clear out monitor encounters a canceled processing request, the processing engine system 104 causes the clear out monitor to push the processing request out of the local processing resource regardless of if the processing resource has completed processing. In these implementations, the processing engine system 104 ensures that canceled processing requests do not tie up or further access to local resources. In some implementations, the processing engine system 104 causes the clear out monitor to follow and wait for all outstanding processing requests to process to completion at a local processing resource.

In one or more implementations, the processing engine system 104 allows pending processing requests to enter a local processing resource after the clear out monitor enters the local processing resource, but before the clear out monitor has exited the local processing resource. In particular, in various implementations, the clear out monitor is sent to a local processing resource in connection with receiving a target cancellation request, which triggers the modification of the sequence number of canceled processing requests. Accordingly, the processing engine system 104 allows only valid processing requests to enter the local processing resource after the clear out monitor enters it. Thus, the processing engine system 104 improves efficiency by allowing valid, pending processing requests to be processed by local processing resources without needing to wait for the local processing resource to fully flush out outstanding processing requests. In alternative implementations, the processing engine system 104 prevents sending resources from entering a local processing resource until it has been flushed out, as indicated by the clear out monitor exiting the local processing resource.

By utilizing the clear out monitor and/or a processing request completion indicator, the processing engine system 104 need not track down or chased after specific processing requests that have been canceled that may be processed locally. Indeed, by flushing out all current processing and outstanding processing requests across local processing resources, the processing engine system 104 ensures that any processing requests that may be included in a recently identified cancellation request no longer have access to local processing resources. In this manner, the processing engine system 104 provides a flexible and elegant solution over needing to track down and/or chase after canceled processing requests that are located somewhere locally in the request processing flow.

As shown, the series of acts 600 includes an act 608 of returning the clear out monitor to indicate all pending processing requests are complete. For instance, the processing engine system 104 identifies a processed clear out monitor and/or a processed/positive processing request completion indicator that a local processing resource is free of any canceled processing requests (with respect to the target cancellation request). Indeed, by returning the clear out monitor, the processing engine system 104 can guarantee that the target canceled requests are no longer able to access resources that they previously accessed, as these resources have been deallocated and potentially allocated to fulfilling new processing requests.

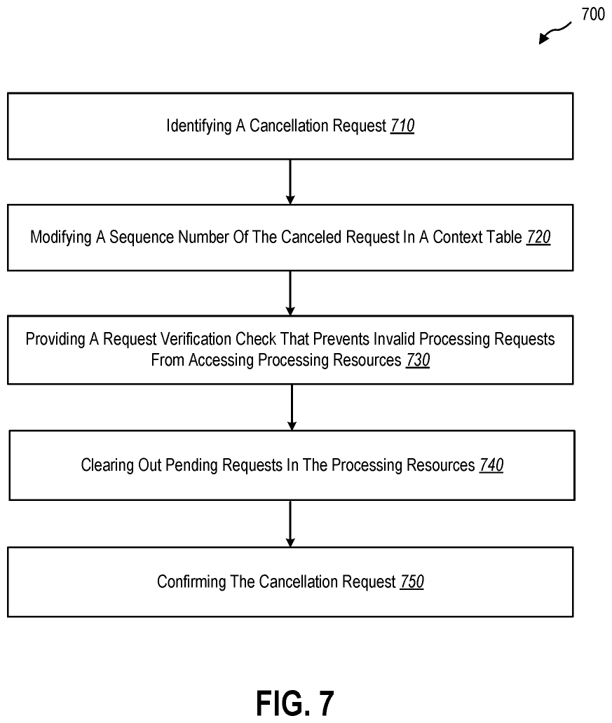

Turning now to FIG. 7, this figure illustrates an example flowchart that includes a series of acts 700 for utilizing the processing engine system 104 in accordance with one or more implementations. In particular, FIG. 7 illustrates an example series of acts 700 for persisting monitored and processed event data to a persistence store in accordance with one or more implementations. Furthermore, the acts of FIG. 7 can be performed as part of a method. Alternatively, a non-transitory computer-readable medium can include instructions that, when executed by one or more processors, cause a computing device to perform the acts 700 of FIG. 7. In still further implementations, a system can perform the acts 700 of FIG. 7. In some implementations, a processing engine performs one or more of the acts of the series of acts 700.

As shown, the series of acts 700 includes an act 710 of identifying a cancellation request. For instance, in example implementations, the act 710 involves identifying a cancellation indication to cancel a service request that is currently being processed.

In various implementations, the processing request is a remote processing request sent to a remote computing device for processing, the remote processing request is sent to the remote computing device with a token including a context identifier and the sequence number for the processing request, and/or the cancellation indication is identified and/or received while the remote processing request is at the remote computing device.

As further shown, the series of acts 700 includes an act 720 of modifying a sequence number of the canceled request in a context table. For instance, in example implementations, the act 720 involves modifying a sequence number to generate a modified sequence number at a target context entry of a request context table to indicate the target context entry as invalid, the target context entry including a request context for a processing request being associated with the service request in response to the cancellation indication. In some implementations, the act 720 includes generating the modified sequence number at the target context entry of the request context table by changing the most-significant bit of the sequence number or adding a number to the sequence number.

As further shown, the series of acts 700 includes an act 730 of providing a request verification check that prevents invalid processing requests from accessing processing resources. For instance, in example implementations, the act 730 involves providing a request verification check before a local processing resource that prevents invalid processing requests from accessing the local processing resource. In some implementations, the act 730 includes identifying the target context entry for the processing request in the request context table by utilizing a context identifier within the token of the processing request to identify the target context entry.

In example implementations, the act 730 includes the request verification check being present at the local processing resource before the processing request arrives at the local processing resource to be processed. In various implementations, providing the request verification check before the local processing resource includes determining that the sequence number associated with the processing request is invalid based on the sequence number within a token associated with the processing request not matching the sequence number in the target context entry for the processing request in the request context table. In additional implementations, the act 730 includes, based on determining that the processing request is invalid, preventing the processing request from accessing the local processing resource and/or dropping the processing request.

As further shown, the series of acts 700 includes an act 740 of clearing out pending requests in the processing resources. For instance, in example implementations, the act 740 involves providing a processing request completion indicator to the local processing resource to verify that any processing requests associated with the service request that arrives at the local processing resource before the arrival of the processing request completion indicator have completed processing. In some implementations, the act 740 includes pushing outstanding or waiting processing requests in the local processing resource out utilizing the processing request completion indicator.

As further shown, the series of acts 700 includes an act 750 of confirming the cancellation request. For instance, in example implementations, the act 750 involves confirming the cancellation of the service request by indicating that the local processing resource will not be accessed to further process the processing request associated with the service request. In some implementations, the act 750 includes utilizing the processing request completion indicator to clear out any processing request currently in the local processing resource upon arrival of the processing request completion indicator and/or returning the processing request completion indicator to indicate that the local processing resource has been cleared out.

In some implementations, the series of acts 700 includes additional acts. For example, in certain implementations, the series of acts 700 includes acts of receiving, at a processing engine, the service request requesting a returned result and in response to receiving the service request, generating the processing request by adding the request context for the processing request to a context entry in the request context table. In various implementations, the request context for the processing request includes a context identifier, the sequence number, and request servicing information. In various implementations, the series of acts 700 includes an act of identifying the processing request generated in response to receiving the service request within the request context table.

In some implementations, the series of acts 700 includes an act of overwriting data in the target context entry after the target context entry is marked as invalid. In various implementations, overwriting the data in the target context entry includes generating a new sequence number while maintaining the context identifier for the target context entry.

In example implementations, the series of acts 700 includes receiving a processing result for a remote processing request from the remote computing device where the processing result includes a token; providing the processing result and the token to the local processing resource; and/or determining, utilizing the request verification check, that the processing request has been invalidated based on the sequence number in the token not matching the modified sequence number.

In some implementations, the series of acts 700 includes determining that an additional sequence number associated with an additional processing request is valid based on the additional sequence number within an additional token associated with the additional processing request matching the additional sequence number in an additional context entry for the additional processing request in the request context table and, based on the additional processing request being valid, allowing the additional processing request to access the local processing resource. In various implementations, the additional processing request enters the local processing resource behind the processing request completion indicator and before the processing request completion indicator clears out the local processing resource of the outstanding processing requests (e.g., processing requests that precede the arrival of the processing request completion indicator).

In certain implementations, the series of acts 700 includes receiving, from a remote processing service, the processing result of a remote processing request, where the remote processing request was sent to the remote processing service based on the service request, and where the processing result includes a token having a context identifier for the target context entry and the sequence number; and/or dropping the processing result based on determining that the sequence number in the token does not match the modified sequence number in the target context entry.

In one or more implementations, the series of acts 700 includes receiving a processing result for the remote processing request from the remote computing device after modifying the sequence number at the target context entry (i.e., request context), where the processing result includes the token; providing the processing result and the token to the local processing pipeline resource; and/or determining, utilizing the request verification check before access is allowed to the local processing pipeline resource, that the processing request has been invalidated based on the sequence number in the token not matching the modified sequence number. For many implementations, the processing engine includes a hardware accelerator and/or local processing pipeline resource that includes an on-chip pipeline.

A “computer network” (hereinafter “network”) is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmission media can include a network and/or data links that can be used to carry the needed program code means in the form of computer-executable instructions or data structures and which can be accessed by a general-purpose or special-purpose computer. Combinations of the above should also be included within the scope of computer-readable media.

In addition, the network (i.e., computer network) described herein may represent a network or collection of networks (such as the Internet, a corporate intranet, a virtual private network (VPN), a local area network (LAN), a wireless local area network (WLAN), a cellular network, a wide area network (WAN), a metropolitan area network (MAN), or a combination of two or more such networks) over which one or more computing devices may access the processing engine system 104. Indeed, the networks described herein may include one or multiple networks that use one or more communication platforms or technologies for transmitting data. For example, a network may include the Internet or other data link that enables transporting electronic data between respective client devices and components (e.g., server devices and/or virtual machines thereon) of the cloud computing system.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network (i.e., computer network) or data link can be buffered in RAM within a network interface module (NIC), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions include, for example, instructions and data that, when executed by a processor, cause a general-purpose computer, special purpose computer, or special purpose processing device to perform a certain function or group of functions. In some implementations, computer-executable instructions are executed by a general-purpose computer to turn the general-purpose computer into a special-purpose computer implementing elements of the disclosure. The computer-executable instructions may include, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

FIG. 8 illustrates certain components that may be included within a computer system 800. The computer system 800 may be used to implement the various computing devices, components, and systems described herein.

In various implementations, the computer system 800 may represent one or more of the client devices, server devices, or other computing devices described above. For example, the computer system 800 may refer to various types of network devices capable of accessing data on a network (i.e., a computer network), a cloud computing system, or another system. For instance, a client device may refer to a mobile device such as a mobile telephone, a smartphone, a personal digital assistant (PDA), a tablet, a laptop, or a wearable computing device (e.g., a headset or smartwatch). A client device may also refer to a non-mobile device such as a desktop computer, a server node (e.g., from another cloud computing system), or another non-portable device.

The computer system 800 includes a processor 801. The processor 801 may be a general-purpose single- or multi-chip microprocessor (e.g., an Advanced RISC (Reduced Instruction Set Computer) Machine (ARM)), a special purpose microprocessor (e.g., a digital signal processor (DSP)), a microcontroller, a programmable gate array, etc. The processor 801 may be referred to as a central processing unit (CPU). Although the processor 801 shown is just a single processor in the computer system 800 of FIG. 8, in an alternative configuration, a combination of processors (e.g., an ARM and DSP) could be used.

The computer system 800 also includes memory 803 in electronic communication with the processor 801. The memory 803 may be any electronic component capable of storing electronic information. For example, the memory 803 may be embodied as random-access memory (RAM), read-only memory (ROM), magnetic disk storage media, optical storage media, flash memory devices in RAM, on-board memory included with the processor, erasable programmable read-only memory (EPROM), electrically erasable programmable read-only memory (EEPROM), registers, and so forth, including combinations thereof.

The instructions 805 and the data 807 may be stored in the memory 803. The instructions 805 may be executable by the processor 801 to implement some or all of the functionality disclosed herein. Executing the instructions 805 may involve the use of the data 807 that is stored in the memory 803. Any of the various examples of modules and components described herein may be implemented, partially or wholly, as instructions 805 stored in memory 803 and executed by the processor 801. Any of the various examples of data described herein may be among the data 807 that is stored in memory 803 and used during the execution of the instructions 805 by the processor 801.

A computer system 800 may also include one or more communication interface(s) 809 for communicating with other electronic devices. The one or more communication interface(s) 809 may be based on wired communication technology, wireless communication technology, or both. Some examples of the one or more communication interface(s) 809 include a Universal Serial Bus (USB), an Ethernet adapter, a wireless adapter that operates in accordance with an Institute of Electrical and Electronics Engineers (IEEE) 802.11 wireless communication protocol, a Bluetooth® wireless communication adapter, and an infrared (IR) communication port.

A computer system 800 may also include one or more input device(s) 811 and one or more output device(s) 813. Some examples of the one or more input device(s) 811 include a keyboard, mouse, microphone, remote control device, button, joystick, trackball, touchpad, and light pen. Some examples of the one or more output device(s) 813 include a speaker and a printer. A specific type of output device that is typically included in a computer system 800 is a display device 815. The display device 815 used with implementations disclosed herein may utilize any suitable image projection technology, such as liquid crystal display (LCD), light-emitting diode (LED), gas plasma, electroluminescence, or the like. A display controller 817 may also be provided, for converting data 807 stored in the memory 803 into text, graphics, and/or moving images (as appropriate) shown on the display device 815.

The various components of the computer system 800 may be coupled together by one or more buses, which may include a power bus, a control signal bus, a status signal bus, a data bus, etc. For the sake of clarity, the various buses are illustrated in FIG. 8 as a bus system 819.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or a combination of hardwired and wireless data links) through a network (i.e., computer network), both perform tasks. In a distributed system environment, program modules may be located in both local and remote memory storage devices.

The techniques described herein may be implemented in hardware, software, firmware, or any combination thereof unless specifically described as being implemented in a specific manner. Any features described as modules, components, or the like may also be implemented together in an integrated logic device or separately as discrete but interoperable logic devices. If implemented in software, the techniques may be realized in part by a non-transitory processor-readable storage medium including instructions that, when executed by at least one processor, perform one or more of the methods described herein. The instructions may be organized into routines, programs, objects, components, data structures, etc., which may perform particular tasks and/or implement particular data types, and which may be combined or distributed as desired in various implementations.

Computer-readable media can be any available media that can be accessed by a general-purpose or special-purpose computer system. Computer-readable media that store computer-executable instructions are non-transitory computer-readable storage media (devices). Computer-readable media that carry computer-executable instructions are transmission media. Thus, by way of example, and not limitation, implementations of the disclosure can include at least two distinctly different kinds of computer-readable media: non-transitory computer-readable storage media (devices) and transmission media.

As used herein, non-transitory computer-readable storage media (devices) may include RAM, ROM, EEPROM, CD-ROM, solid-state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general-purpose or special-purpose computer.

The steps and/or actions of the methods described herein may be interchanged with one another without departing from the scope of the claims. In other words, unless a specific order of steps or actions is required for the proper operation of the method that is being described, the order and/or use of specific steps and/or actions may be modified without departing from the scope of the claims.

The term “determining” encompasses a wide variety of actions and, therefore, “determining” can include calculating, computing, processing, deriving, investigating, looking up (e.g., looking up in a table, a database, or another data structure), ascertaining, and the like. Also, “determining” can include receiving (e.g., receiving information), accessing (e.g., accessing data in a memory), and the like. Also, “determining” can include resolving, selecting, choosing, establishing, and the like.

The terms “comprising,” “including,” and “having” are intended to be inclusive and mean that there may be additional elements other than the listed elements. Additionally, it should be understood that references to “one implementation” or “implementations” of the present disclosure are not intended to be interpreted as excluding the existence of additional implementations that also incorporate the recited features. For example, any element or feature described concerning an implementation herein may be combinable with any element or feature of any other implementation described herein, where compatible.

The present disclosure may be embodied in other specific forms without departing from its spirit or characteristics. The described implementations are to be considered illustrative and not restrictive. The scope of the disclosure is therefore indicated by the appended claims rather than by the foregoing description. Changes that come within the meaning and range of equivalency of the claims are to be embraced within their scope.

What is claimed is:

1. A computer-implemented method comprising:
identifying a cancellation indication to cancel a service request that is currently being processed;
in response to the cancellation indication, modifying a sequence number to generate a modified sequence number at a target context entry of a request context table to indicate the target context entry as invalid, the target context entry comprising a request context for a processing request being associated with the service request;
providing a request verification check before a local processing resource that prevents invalid processing requests from accessing the local processing resource;
providing a processing request completion indicator to the local processing resource to verify that any processing requests associated with the service request that arrive at the local processing resource before arrival of the processing request completion indicator have completed processing; and
confirming cancellation of the service request by indicating that the local processing resource will not be accessed to further process the processing request associated with the service request.

2. The computer-implemented method of claim 1, further comprising:
receiving, at a processing engine, the service request requesting a returned result; and
in response to receiving the service request, generating the processing request by adding the request context for the processing request to a context entry in the request context table, wherein the request context for the processing request comprises a context identifier, the sequence number, and request servicing information.

3. The computer-implemented method of claim 2, wherein identifying the cancellation indication to cancel the service request comprises identifying the processing request generated in response to receiving the service request within the request context table.

4. The computer-implemented method of claim 3, wherein generating the modified sequence number at the target context entry of the request context table comprises changing a most-significant bit of the sequence number or adding a number to the sequence number.

5. The computer-implemented method of claim 3, wherein:
the request verification check is present at the local processing resource before the processing request arrives at the local processing resource to be processed; and
providing the request verification check before the local processing resource comprises determining that the sequence number associated with the processing request is invalid based on the sequence number within a token associated with the processing request not matching the sequence number in the target context entry for the processing request in the request context table.

6. The computer-implemented method of claim 5, further comprising:
based on determining that the processing request is invalid:
preventing the processing request from accessing the local processing resource; and
dropping the processing request.

7. The computer-implemented method of claim 5, further comprising identifying the target context entry for the processing request in the request context table by utilizing a context identifier within the token of the processing request to identify the target context entry.

8. The computer-implemented method of claim 2, further comprising overwriting data in the target context entry after the target context entry is marked as invalid, wherein overwriting the data in the target context entry comprises generating a new sequence number while maintaining the context identifier for the target context entry.

9. The computer-implemented method of claim 1, wherein providing the processing request completion indicator to the local processing resource comprises:
utilizing the processing request completion indicator to clear out any processing request currently in the local processing resource upon arrival of the processing request completion indicator; and
returning the processing request completion indicator to indicate that the local processing resource has been cleared out.

10. The computer-implemented method of claim 1, wherein:
the processing request is a remote processing request sent to a remote computing device for processing;
the remote processing request is sent to the remote computing device with a token comprising a context identifier and the sequence number for the processing request; and
the cancellation indication is identified while the remote processing request is at the remote computing device.

11. The computer-implemented method of claim 10, further comprising:
receiving a result for the remote processing request from the remote computing device, the result comprising the token;
providing the result and the token to the local processing resource; and
determining, utilizing the request verification check, that the processing request has been invalidated based on the sequence number in the token not matching the modified sequence number.

12. A processing engine comprising:
a memory comprising a request context table having context entries each comprising a context identifier, a unique sequence number, and request servicing information;
a local processing resource for processing one or more processing requests; and
the processing engine is programmed to:
identify a cancellation indication to cancel a service request that is currently being processed;
in response to the cancellation indication, modify a sequence number to generate a modified sequence number within a target context entry of the context entries of the request context table, wherein the target context entry represents a processing request associated with the service request, and wherein modifying the sequence number invalidates the processing request;
provide a request verification check before the local processing resource that prevents invalid processing requests from accessing the local processing resource;
in response to the cancellation indication, provide a processing request completion indicator to the local processing resource to verify that processing requests at the local processing resource that precede arrival of the processing request completion indicator have completed processing at the local processing resource; and
confirm cancellation of the service request by indicating that the local processing resource will not be accessed to further process the processing request associated with the service request.

13. The processing engine of claim 12, wherein the processing engine is further programmed to modify the sequence number at the target context entry of the request context table by changing a most-significant bit of the sequence number or adding a number to the sequence number.

14. The processing engine of claim 12, wherein providing the request verification check before the local processing resource comprises:
determining that an additional sequence number associated with an additional processing request is valid based on the additional sequence number within an additional token associated with the additional processing request matching the additional sequence number in an additional context entry for the additional processing request in the request context table; and
based on the additional processing request being valid, allowing the additional processing request to access the local processing resource.

15. The processing engine of claim 14, wherein the additional processing request enters the local processing resource behind the processing request completion indicator and before the processing request completion indicator clears out the local processing resource of processing requests that precede the arrival of the processing request completion indicator.

16. A computer-implemented method comprising:
identifying, by a processing engine, a cancellation indication to cancel a service request that is currently being processed;
in response to the cancellation indication, modifying a sequence number to generate a modified sequence number at a target context entry of a request context table to indicate the target context entry as invalid, the target context entry comprising a request context for a processing request being associated with the service request;
providing, at the processing engine, a request verification check before a local processing pipeline resource that prevents invalid processing requests from accessing the local processing pipeline resource;
providing, at the processing engine, a processing request completion indicator to a local processing pipeline resource to verify that any local processing requests triggered in response to the service request have, if started before receiving the processing request completion indicator, complete processing at the local processing pipeline resource;
receiving, from a remote processing service, a processing result of a remote processing request, wherein the remote processing request was sent to the remote processing service based on the service request, and wherein the processing result comprises a token having a context identifier for the target context entry and the sequence number; and
dropping the processing result based on determining that the sequence number in the token does not match the modified sequence number in the target context entry.

17. The computer-implemented method of claim 16, further comprising confirming, by the processing engine, cancellation of the service request by indicating that the local processing pipeline resource will not be accessed to further process the service request.

18. The computer-implemented method of claim 16, wherein:
the processing request is a remote processing request sent to a remote computing device for processing;
the remote processing request is sent to the remote computing device with a token comprising a context identifier and the sequence number for the processing request; and
the cancellation indication is identified while the remote processing request is at the remote computing device.

19. The computer-implemented method of claim 18, further comprising:
receiving the processing result from the remote computing device after modifying the sequence number at the target context entry, wherein the processing result comprises the token;
providing the processing result and the token to the local processing pipeline resource; and
determining, utilizing the request verification check before access is allowed to the local processing pipeline resource, that the processing request has been invalidated based on the sequence number in the token not matching the modified sequence number.

20. The computer-implemented method of claim 18, wherein the processing engine comprises a hardware accelerator, and wherein the local processing pipeline resource comprises an on-chip pipeline.
